(19) United States
(12) Patent Application Publication
(10) Pub. No.: US 2009/0248654 A1
(43) Pub. Date: Oct. 1, 2009

(54) SYSTEM AND METHOD FOR PROCESSING MAIL USING SENDER AND RECIPIENT NETWORKED MAIL PROCESSING SYSTEMS

(75) Inventors: Michael J. Critelli, Darien, CT (US); Judith D. Auslander, Westport, CT (US); Robert A. Cordery, Danbury, CT (US); Leon A. Pintsov, West Hartford, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/055,540

(22) Filed: Mar. 26, 2008

(51) Int. Cl. G06F 7/06; G06F 17/30; G06F 15/16

(52) U.S. Cl. 707/5; 709/206; 707/E17.018; 707/E17.017

(57) ABSTRACT

Systems and methods for allowing the sender of a mail piece to obtain an accurate recipient address for the mail piece when the mail piece is being prepared are provided. The mail processing systems of the sender and recipient businesses are networked such that communication can occur between them. When the sender is preparing a mail piece for delivery to a recipient, the sender can participate in an interactive session with the recipient's mail room, utilizing the networked mail processing systems, to obtain a correct recipient address for a mail piece based on a database of recipient addresses maintained by the recipient's mail processing system. Since the mail piece is provided with an accurate recipient address, upon receipt of the mail piece by the recipient's mail room the mail piece can be properly delivered without requiring significant work by the recipient's mailroom to determine the appropriate intended recipient.

### FIELD OF THE INVENTION

The invention disclosed herein relates generally to mail processing systems, and more particularly to networked mail processing systems that operate to increase the efficiency of mail delivery.

### BACKGROUND OF THE INVENTION

Numerous postal systems have been developed around the world for the delivery of mail pieces, e.g., letters, flats, packages, and the like. Every postal system operates on the basis of a mailing address, which is a unique formal description of the structure to where a mail piece is to be delivered. The primary purpose of mail pieces is to communicate information fundamentally designed for human consumption. This means that besides a mailing address, there is typically a designated recipient, i.e., the name and/or internal location of a person or a function within a business where a mail piece is to be ultimately delivered, also referred to herein as a recipient address. Unfortunately, internal addresses within a business or corporation tend to be quite dynamic, as people often move locations within a company, change job functions, leave the company, or are replaced by new employees. As such, mail senders often do not have accurate information when trying to determine the appropriate recipient address for a mail piece, resulting in mail pieces that either include an incorrect recipient address or a generic recipient address. In either situation, the mail piece may be undeliverable or require significant work by the recipient's mailroom to determine the appropriate intended recipient, resulting in increased operating costs for the recipient's mailroom, as well as a delay in the delivery of the mail piece.

It would be desirable, therefore, for a sender of a mail piece to be able to obtain an accurate recipient address for the mail piece when the mail piece is being prepared.

### SUMMARY OF THE INVENTION

The present invention alleviates the problems associated with the prior art and provides a system and method for allowing the sender of a mail piece to obtain an accurate recipient address for the mail piece when the mail piece is being prepared.

In accordance with the present invention, the mail processing systems of the sender and recipient businesses are networked such that communication can occur between them. When the sender is preparing a mail piece for delivery to a recipient, the sender can participate in an interactive session with the recipient's mail room, utilizing the networked mail processing systems, to obtain a correct recipient address for a mail piece based on a database of recipient addresses maintained by the recipient's mail processing system. Optionally, the recipient address can be only a delivery code to maintain the privacy of the name of the actual employee that should receive the mail piece. Since the mail piece is provided with an accurate recipient address (or code that identifies internally to the recipient's mail room the actual recipient address), upon receipt of the mail piece by the recipient's mail room the mail piece can be properly delivered without requiring significant work by the recipient's mailroom to determine the appropriate intended recipient.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a mailroom communication network according to an embodiment of the present invention;

FIG. 2 illustrates an example of a mail processing system utilized in the mailroom communication network according to an embodiment of the present invention;

FIG. 3 illustrates in flow chart form an example of the processing performed during preparation of a mail piece using the mailroom communication network; and

FIG. 4 illustrates in flow chart form an example of the processing performed when a mail piece is received.

### DETAILED DESCRIPTION OF THE PRESENT INVENTION

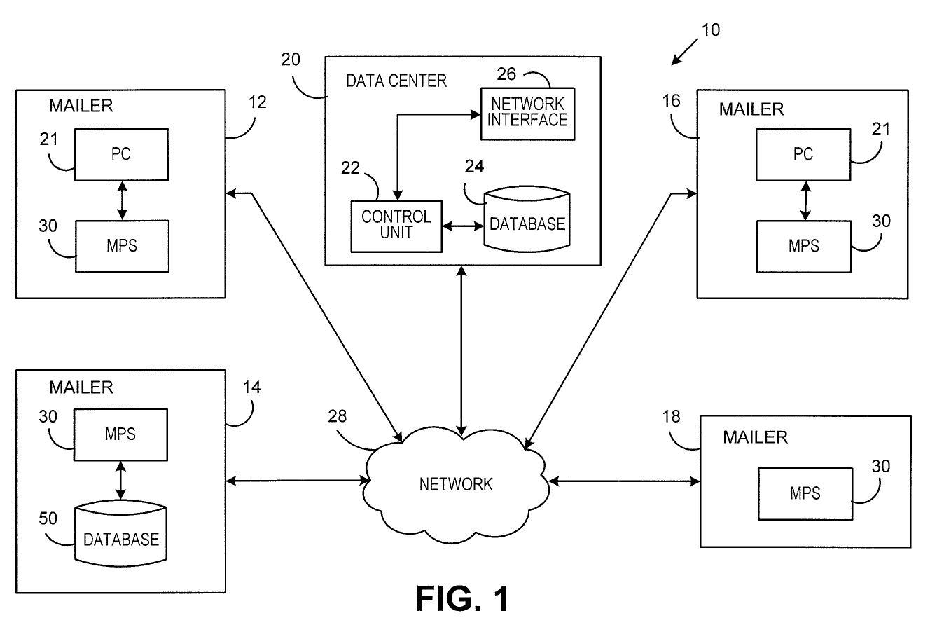

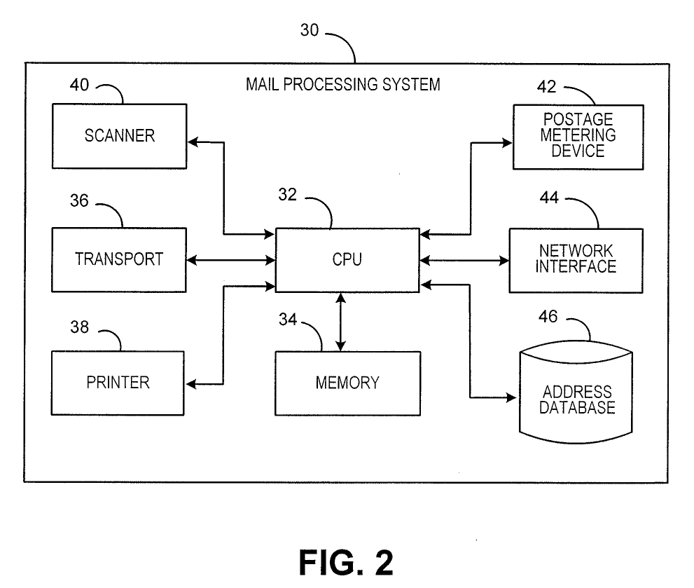

In describing the present invention, reference is made to the drawings, wherein there is seen in FIG. 1 a mailroom communication network 10 according to an embodiment of the present invention. Network 10 includes a plurality of mailers, e.g., mailer 12, mailer 14, mailer 16, mailer 18. While only four mailers are illustrated in FIG. 1, it should be understood that any number of mailers may be part of the network 10. Each mailer 12-18 may be, for example, a business, corporation, or any other type of entity that has multiple employees with different internal addresses within the entity. Each mailer 12-18 operates one or more mail processing systems (MPS) 30 (described further below with respect to FIG. 2) to process both outgoing and incoming mail. Each MPS 30 may be used to process both incoming and outgoing mail, or alternatively an MPS 30 may be dedicated to only processing one of outgoing mail or incoming mail. The mailers can optionally include one or more personal computers (PC) 21 that are coupled to the MPS 30 via an internal network, such as illustrated for mailer 12 and mailer 16 in FIG. 1.

Each of the mailers 12-18 is adapted to communicate with a central data center 20. Such communications can be done utilizing any type of communication network 28, such as, for example, the Internet, a telephone network, or the like. Optionally, each of the mailers 12-18 can communicate directly with one or more of the other mailers 12-18 utilizing the network 28. Data center 20 preferably includes a control unit 22 and can optionally include one or more databases 24, as will be described below. Control unit 22 can be, for example, a processing unit or the like that is adapted to control operation of the data center 20. Data center 20 includes a network interface 26 that provides the necessary communication hardware/software required for the data center 20 to communicate via the network 28 with the mail processing systems 30 operated by the mailers 12-18.

FIG. 2 illustrates in block diagram form a mail processing system 30 that can be utilized by each of the mailers 12-18 of FIG. 1. Each mail processing system 30 can be, for example, a dedicated mailing machine, a separate computer system, a combination of the two, or any other type of device that can be utilized to process outgoing and/or incoming mail pieces. There are many different types of mailing machines, ranging from relatively small units that handle only one mail piece at a time, to large, multi-functional units that can process hundreds of mail pieces per hour in a continuous stream operation. MPS 30 includes a central processing unit 32, which can include, for example, one or more special or general purpose processing devices. The CPU 32 controls operation of the MPS 30 using instructions stored in one or more memory units 34. If the MPS 30 is a dedicated mailing machine, it can optionally include a transport 36, such as, for example, rollers and belts, that automate the processing of mail pieces by transporting the mail pieces through the MPS 30. Such transport systems are well known in the art.

The CPU 32 communicates with a postage metering device 42 that is utilized to generate indicia to evidence payment of postage for mail pieces. Postage metering device 42 is preferably a secure coprocessor that performs cryptographic operations and keeps track of funds by maintaining a descending register which stores an amount of funds available for use and an ascending register which stores a total amount of funds dispensed over the life of the metering device 42. Funds may be added to the descending register by any conventional means. A printer 38 is used to print information on the mail pieces, such as, for example, indicia generated by the postage metering device 42, address information (either or both of the sender and recipient), ad slogans, and the like. Printer 38 may be, for example, an ink jet printer or other conventional type of printing device. A scanning or reading device 40 is provided to scan information printed on the mail pieces. A network interface 44 provides the necessary communication hardware/software required for the MPS 30 to communicate via the network 28 with the data center 20 and other MPS 30 operated by mailers 12-18, and also to communicate via an internal network with devices internal to the mailer, e.g., PC 21.

MPS 30 also preferably includes an address database 46 that is utilized to store employee names, titles, roles, code names, identification numbers, etc., along with an internal address for each employee, that enables an employee to be identified internally and located within the mailer's company. Alternatively, MPS 30 need not include its own address database 46, and instead each mailer can maintain an address database separate from the MPS 30, such as, for example, database 50 for mailer 14 as illustrated in FIG. 1, that is accessible by the MPS 30 via an internal network. As yet another alternative, one or more mailers 12-18 can utilize the database 24 located at the data center 20 to store employee information as indicated above.

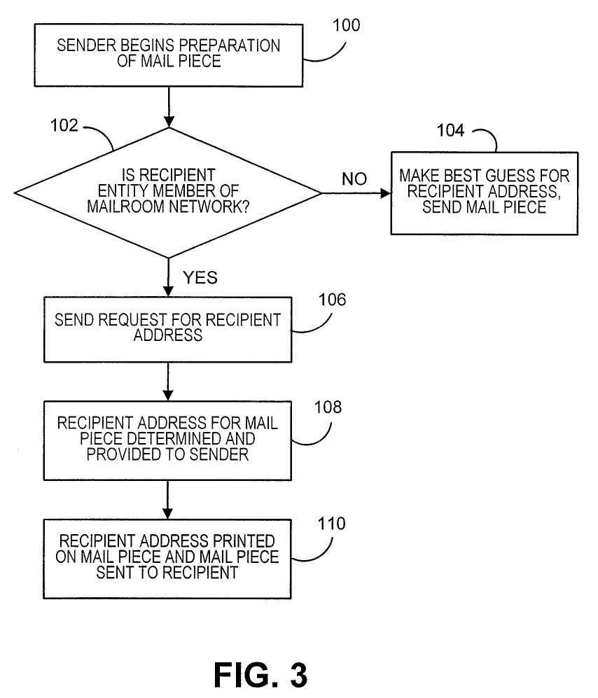

FIG. 3 illustrates in flow chart form an example of the processing performed during preparation of a mail piece using the mailroom communication network 10 to determine an accurate recipient address for the mail piece. The process beings in step 100 where a sender, such as, for example, mailer 12 of FIG. 1, begins preparation of a mail piece to be delivered to a recipient, e.g., mailer 14 of FIG. 1. When the sender of a mail piece begins the preparation of the mail piece, the sender has a purpose for the communication and as such has some information with respect to the desired recipient, such as, for example, a name, job title, role, and a delivery address. Using the mailroom network 10, the sender can obtain an accurate recipient address thereby ensuring proper delivery of the mail piece. In step 102, the sender (mailer 12) will determine if the intended recipient (mailer 14) is a member of the mailroom network 10. This can be performed, for example, by the MPS 30 of mailer 12 communicating with data center 20 and requesting confirmation if the intended recipient has registered with the data center 20. The request can include, for example, the name and mailing address of mailer 14 as known by mailer 12. Optionally, the request for confirmation generated by the MPS 30 can be cryptographically protected, such as for example by encryption or with a digital signature, thereby maintaining privacy of the request and allowing the data center 20 to verify that the request is coming from an authorized MPS 30 that is part of the network 10. Alternatively, such a request can be initiated at the PC 21, sent to the MPS 30 using an internal network, and then from the MPS 30 to the data center 20 via network 28. The data center 20 can determine if the mailer 14 is a member of the network 10 based on the mailing address of mailer 14. If the intended recipient is not a member of the mailroom network 10, then in step 104 the data center 20 will notify the sender of such and the sender must simply make a best guess as to the recipient address within the recipient entity, address the mail piece using the best guess, and send the mail piece, hoping that it is delivered internally within the recipient entity to the proper recipient address.

If the intended recipient is a member of the mailroom network, such as mailer 14, then in step 106 the sender will receive confirmation from the data center 20 that mailer 14 is a member of the mailroom network 10, and the sender (mailer 12) will generate and send a request, using the MPS 30, for a correct recipient address for the mail piece. This request includes information associated with the desired recipient based on the purpose of the communication, such as, for example, a specific individual, a job title, a job function within the recipient entity, or any other information that will enable the recipient entity to identify a correct recipient address. This request can be sent to the data center 20 via the network 28. The data center 20 can respond to the request, using the database 24 maintained by the data center 20. Alternatively, the data center 20 can forward the request to the MPS 30 of the intended recipient (mailer 14). As yet another alternative, the response from the data center 20 confirming that the recipient entity is a member of the mailroom network 10 can include a network address for the recipient entity, and the request from MPS 30 of mailer 12 can be sent directly to MPS 30 of mailer 14 via the network 28.

In step 108, a correct recipient address for the mail piece is determined, based on the information included in the request, and provided to the sender (either from the data center 20 or the recipient entity). It should be noted that the determination of a correct recipient address may require more than one communication, and can include a series of communications, especially if a match based on the request cannot initially be found. If the determination of the correct recipient address is being performed by the MPS 30 of mailer 14, the determination can be performed by comparing the information in the request to the information stored in the address database 46, or alternatively in the database 50 (if provided). If the determination is being performed by the data center 20, the determination can be performed by comparing the information in the request to the information stored in the database 24. Optionally, the sender may be required to pay a fee for obtaining recipient address information. The determination as to whether or not the recipient requires a fee to provide recipient address information can be based on the identity of the sending party. Such payment can occur directly between the MPS 30 of mailer 12 and the MPS 30 of mailer 14 (by updating the registers maintained in the postage metering devices 42), or by other conventional means, e.g., using a credit card and data center 20.

In some instances, the recipient entity may not wish to provide (or have the datacenter 20 provide) actual employee names and/or locations. In such a situation, instead of providing a recipient address including the actual name and location of a specific employee, the recipient address can simply include a delivery code that is associated with an actual employee name and location internally to the recipient entity. The delivery code could be randomly or pseudo-randomly generated such that it is unique for each mail piece. Alternatively, an alias could also be used that is associated with an actual employee name and location. The decision of whether or not to provide an actual employee name and location, or simply a delivery code or alias, could be based on the identity of the requesting party. A delivery code or alias could be associated with an expiration date, after which mail having the delivery code or alias as the recipient address would not be accepted by the recipient (mailer 14).

In some situations, a request may result in a match with more than one name, such as, for example, a request for a recipient address associated with a job function or title. In such situations, the MPS 30 of the intended recipient can determine if more than one recipient address should be provided. This can be based on predetermined rules established by the mailer 14, and programmed into the MPS 30 of mailer 14. Such rules could include, for example, the provision of only a single recipient address for any request, the provision of some maximum number of recipient addresses for any request, etc. The rules could also be based on the identity of the requesting party. It is also possible for the MPS 30 of the recipient (mailer 14) to request additional information from the MPS 30 of the sender (mailer 12) in order to resolve ambiguity when more than one match occurs as a result of the request by mailer 12.

The correct recipient address (or addresses) can also be provided with one or more conditions that limit the use of the recipient address by the sender. Such conditions could include, for example, a maximum number of uses, a time period for use, etc. Use of delivery codes and aliases can allow the intended recipient (mailer 14) to determine if the recipient address information is being used within any specified conditions or is being misused by the sender (mailer 12). In the event that the recipient address information is being misused by a particular sender, then the recipient can refuse any subsequent requests for recipient address information from the abusive sender.

In step 110, the sender (mailer 12), having received a correct recipient address, evidences or indicates the recipient address on the mail piece, such as, for example, by printing it on the mail piece or on a label that is applied to the mail piece, and sends the mail piece to the recipient (mailer 14). Optionally, the sender can utilize the correct recipient address to change the location of printing and finishing of the mail piece to a location closer to the correct recipient address. This would be particularly valuable in an environment where the price for delivery of mail pieces is based on different zones, or where minimal delivery time is desired. As noted above, the recipient address can include an actual employee name and location, or may be some type of delivery code that is internally linked by the recipient to an actual employee name and location. Such a code can be printed as an alphanumeric or numeric code, and may be printed either in a text format, a machine readable format, e.g., a barcode, or a combination thereof.

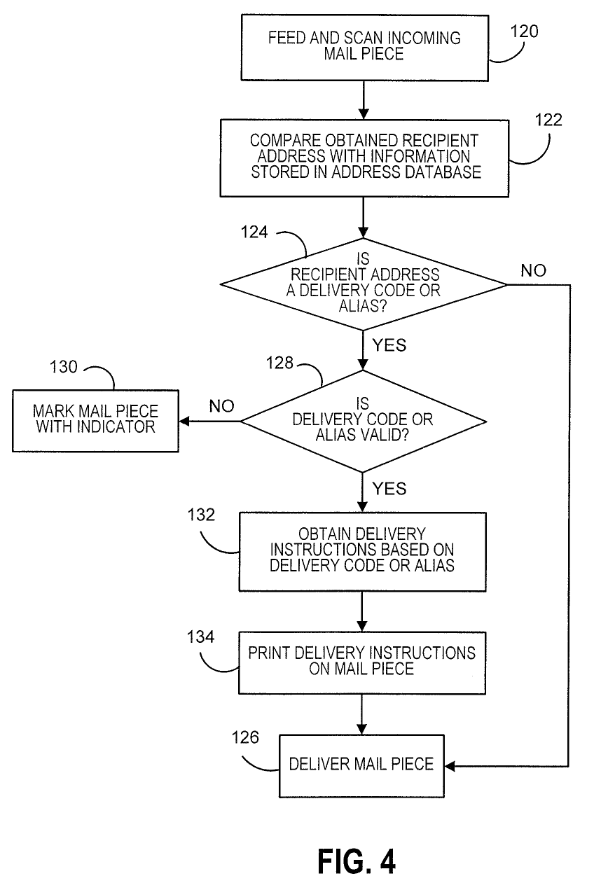

FIG. 4 illustrates in flow chart form the processing performed when a mail piece is received by the recipient entity, such as mailer 14 in the above example. When the mail piece has been received by the mailer 14, in step 120 it is fed into the MPS 30 of mailer 14 and scanned using the scanner 40 to obtain the information on the mail piece. The information scanned from the mail piece can be interpreted, using, for example, optical character recognition routines executed by the CPU 32 of the MPS 30, to determine the recipient address information that is printed on the mail piece. In step 122, the recipient address information obtained from the mail piece is compared with information stored in the address database 46 (or database 50, if provided) by the CPU 32. In step 124, it is determined, preferably by the CPU 32, if the recipient address from the mail piece is a delivery code or alias. If the recipient address is not a delivery code or alias (and therefore is an actual employee name/location) and the actual employee name/location is correct, then in step 126 the mail piece can be passed through the MPS 30 without any further processing and delivered directly to the actual employee without any further investigation as to the correct intended recipient.

If in step 124 it is determined that the recipient address is a delivery code or alias, then in step 128 it is determined if the delivery code or alias is still a valid delivery code or alias, i.e., is in compliance with any restrictions imposed upon the use of the delivery code or alias as previously described. If use of the delivery code or alias is not in compliance with any imposed restrictions, then in step 130 the mail piece can be marked with some type of indicator, using, for example, the printer 38. The indicator will flag the mail piece for the mailroom personnel of the recipient (mailer 14) as a mail piece that should either be returned to the sender, destroyed, retained for further investigation, or any other action desired by the mailer 14. At this point, however, the mail piece will not be delivered to any recipient, and thus the purpose of the communication can not be fulfilled. It should be understood, of course, that if no conditions of use are provided for the delivery code or alias, then the processing as described in steps 128 and 130 need not occur.

If in step 128 it is determined that the delivery code or alias is still valid, then in step 132 the internal delivery instructions for the mail piece, e.g., the name and location of the actual employee to which the mail piece is to be delivered, is determined based on the information stored in the database 46 (or database 50). The use of a delivery code can be useful for those individuals that do not work from a fixed location every day, but instead work in different locations on a frequent basis. Thus, by providing a delivery code and ensuring that the delivery instructions associated with the delivery code that are stored in the database 46 are current, the name and current location to which the mail piece is to be delivered can still easily be determined. Thus, the delivery code could remain constant despite the fact that the delivery instructions associated with the code could change on a daily basis. Optionally, if there is some discrepancy or issue with determining delivery instructions, e.g., the correct recipient address, the MPS 30 of mailer 14 could contact the MPS 30 of mailer 12 to try to resolve the discrepancy and determine a correct recipient address for the mail piece. Once the internal delivery instructions have been determined, then in step 134 the internal delivery instructions, e.g., employee name and location, can be printed on the mail piece using the printer 38 of the MPS 30. The processing performed by the MPS 30 is completed and in step 126, the mail piece can be delivered, using the delivery instructions printed on the mail piece in step 134, by the mailroom personnel.

Thus, according to the present invention, the mail processing systems of the sender (mailer 12) and recipient (mailer 14) businesses are networked such that an interactive session can occur to obtain a correct recipient address for a mail piece before the mail piece is sent to the recipient. Since the mail piece is provided with an accurate recipient address (or code that identifies internally to the recipient's mail room the actual recipient address), upon receipt of the mail piece by the recipient's mail room the mail piece can be properly delivered without requiring significant work by the recipient's mailroom to determine the appropriate intended recipient.

While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for a sender of a mail piece to prepare the mail piece for delivery to a recipient entity, the method comprising:
sending a request, using a mail processing system of the sender that is coupled to a network, to a mail processing system of the recipient entity that is coupled to the network, for a recipient address within the recipient entity;
receiving a response, at the mail processing system of the sender, from the recipient entity mail processing system, the response including a recipient address that the receiving entity desires the sender to use for the mail piece; and
indicating the recipient address on the mail piece.

2. The method of claim 1, wherein before sending a request, the method further comprises:
determining if the mail processing system of the recipient entity is coupled to the network.

3. The method of claim 1, wherein sending a request further comprises:
sending the request to a data center for delivery to the mail processing system of the receiving entity.

4. The method of claim 1, wherein the recipient address includes a delivery code.

5. The method of claim 1, wherein the recipient address includes an employee name and location.

6. The method according to claim 1, wherein the request includes information associated with a desired recipient for the mail piece.

7. The method according to claim 6, wherein the information associated with a desired recipient includes at least one of a job title or job function.

8. The method of claim 1, further comprising:
determining a location for finishing the mail piece based on proximity to the recipient address.

9. A method for providing a sender of a mail piece with a recipient address within a recipient entity, the sender and recipient entity each having a respective mail processing system coupled to a network, the method comprising:
receiving at the recipient entity mail processing system a request from the sender mail processing system for the recipient address within the recipient entity;
comparing, in the recipient entity mail processing system, information included in the request with information stored in a database to determine, based on the information included in the request, a correct recipient address; and
providing the correct recipient address from the recipient entity mail processing system to the sender mail processing system.

10. The method according to claim 9, wherein the correct recipient address includes a delivery code.

11. The method according to claim 9, wherein the correct recipient address includes an alias for an employee of the recipient entity.

12. The method according to claim 9, wherein providing the correct recipient address further comprises:
providing conditions for use of the correct recipient address.
